(19) United States
(12) Patent Application Publication
(10) Pub. No.: US 2022/0394194 A1
(43) Pub. Date: Dec. 8, 2022

(54) COMPUTER-READABLE RECORDING MEDIUM, COMPUTER APPARATUS, AND CONTROL METHOD

(71) Applicant: SQUARE ENIX CO., LTD., Tokyo (JP)

(72) Inventors: Makoto TSUDA, Tokyo (JP); Driancourt REMI, Tokyo (JP)

(73) Assignee: SQUARE ENIX CO., LTD., Tokyo (JP)

(21) Appl. No.: 17/830,053

(22) Filed: Jun. 1, 2022

(30) Foreign Application Priority Data
Jun. 2, 2021 (JP) 2021-93304

(51) Int. Cl. H04N 5/272; H04N 5/232; G06T 7/70

(52) U.S. Cl. CPC H04N 5/272; H04N 5/23219; G06T 7/70; G06T 2207/30242; G06T 2207/30196

(57) ABSTRACT

Computer apparatuses, methods, and non-transitory computer-readable recording media having recorded thereon a program executed in a computer apparatus to perform functions of image processing are provided. An example non-transitory recording medium comprising a program executed in a computer apparatus causes the computer apparatus to perform functions comprising: identifying two or more subjects in a first image from an imaging device; and if the identified two or more subjects satisfy a predetermined condition, superimposing a predetermined effect either on the first image or on a second image from the imaging device that is different from the first image to generate a third image, and providing the third image.

### CROSS REFERENCE TO RELATED APPLICATION(S)

The present application claims priority to Japanese Patent Application No. 2021-093304, filed on Jun. 2, 2021, the disclosure of which is expressly incorporated herein by reference in its entirety for any purpose.

### BACKGROUND

The present disclosure relates to a program, a computer apparatus and a control method.

In recent years, there has been a technology for displaying a virtual object in a real space using augmented reality (AR) technology. Types of display of the virtual object include a marker type using recognition of a predetermined marker (referred to as an AR marker) as a trigger, a solid recognition type using recognition of a solid shape of an object as a trigger, a position recognition type using positional information acquired by a GPS as a trigger, and a space recognition type of causing a terminal apparatus such as a smartphone to recognize a space in a real world and using an operation performed on the terminal apparatus as a trigger.

### SUMMARY

However, there are only AR contents enjoyed by one person in the related art, and users desire a new way of enjoying.

A purpose of at least one embodiment of the present disclosure is to provide a program that generates new interest not existing in the related art.

According to a non-limiting aspect, the present disclosure is to provide a non-transitory computer-readable recording medium having recorded thereon a program executed in a computer apparatus including an imaging unit, the program causing the computer apparatus to perform functions comprising identifying two or more subjects from a first image captured by the imaging unit, and generating, in a case where the identified two or more subjects satisfy a predetermined condition, an image obtained by superimposing a predetermined effect on the first image or a second image that is different from the first image and is captured by the imaging unit.

According to a non-limiting aspect, the present disclosure is to provide a control method executed in a computer apparatus including an imaging unit, the control method comprising identifying two or more subjects from a first image captured by the imaging unit, and generating, in a case where the identified two or more subjects satisfy a predetermined condition, an image obtained by superimposing a predetermined effect on the first image or a second image that is different from the first image and is captured by the imaging unit.

According to a non-limiting aspect, the present disclosure is to provide a non-transitory computer-readable recording medium having recorded thereon a program executed in a server apparatus in a system including a terminal apparatus including an imaging unit, and the server apparatus connectable to the terminal apparatus by communication, the program causing the server apparatus to perform functions comprising identifying two or more subjects from a first image captured by the imaging unit, and generating, in a case where the identified two or more subjects satisfy a predetermined condition, an image obtained by superimposing a predetermined effect on the first image or a second image that is different from the first image and is captured by the imaging unit.

### BRIEF DESCRIPTION OF THE DRAWINGS

FIG. 1 is a block diagram illustrating a configuration of the computer apparatus according to at least one embodiment of the present disclosure.

FIG. 2 is a flowchart of a program execution process according to at least one embodiment of the present disclosure.

FIG. 3 is a block diagram illustrating a configuration of the computer apparatus according to at least one embodiment of the present disclosure.

FIG. 4 is a flowchart of the program execution process according to at least one embodiment of the present disclosure.

FIG. 5 is a block diagram illustrating a configuration of the computer apparatus according to at least one embodiment of the present disclosure.

FIG. 6 is a flowchart of the program execution process according to at least one embodiment of the present disclosure.

FIGS. 7A to 7D are diagrams for describing the captured image according to at least one embodiment of the present disclosure.

FIG. 8 is a flowchart of the program execution process according to at least one embodiment of the present disclosure.

FIGS. 9A to 9D are diagrams for describing the captured image according to at least one embodiment of the present disclosure.

FIG. 10 is a flowchart of the program execution process according to at least one embodiment of the present disclosure.

FIGS. 11A and 11B are diagrams for describing the captured image according to at least one embodiment of the present disclosure.

FIG. 12 is a flowchart of the program execution process according to at least one embodiment of the present disclosure.

FIG. 13 is a flowchart of the program execution process according to at least one embodiment of the present disclosure.

FIGS. 14A and 14B are diagrams for describing the captured images according to at least one embodiment of the present disclosure.

FIG. 15 is a block diagram illustrating a configuration of the system according to at least one embodiment of the present disclosure.

FIG. 16 is a flowchart of the execution process according to at least one embodiment of the present disclosure.

FIG. 17 is a block diagram illustrating a configuration of the system according to at least one embodiment of the present disclosure.

FIG. 18 is a block diagram illustrating a configuration of the system according to at least one embodiment of the present disclosure.

FIG. 19 is a flowchart of the execution process according to at least one embodiment of the present disclosure.

FIG. 20 is a flowchart of the execution process according to at least one embodiment of the present disclosure.

### DESCRIPTION OF EMBODIMENTS

Hereinafter, embodiments of the disclosure will be described with reference to the accompanying drawings. Hereinafter, description relating to effects shows an aspect of the effects of the embodiments of the disclosure, and does not limit the effects. Further, the order of respective processes that form a flowchart described below may be changed in a range without contradicting or creating discord with the processing contents thereof.

### First Embodiment

A summary of a first embodiment of the present disclosure will be described. Hereinafter, a program executed in a computer apparatus including an imaging unit will be illustratively described as the first embodiment.

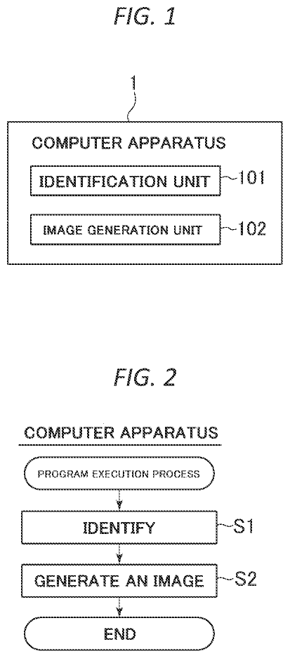

FIG. 1 is a block diagram illustrating a configuration of the computer apparatus according to at least one embodiment of the present disclosure. A computer apparatus 1 includes at least an identification unit 101 and an image generation unit 102.

The identification unit 101 has a function of identifying two or more subjects from a first image captured by the imaging unit. The image generation unit 102 has a function of generating, in a case where the two or more subjects identified by the identification unit 101 satisfy a predetermined condition, an image obtained by superimposing a predetermined effect on the first image or a second image that is different from the first image and is captured by the imaging unit.

Next, an execution process in the first embodiment of the present disclosure will be described. FIG. 2 is a flowchart of a program execution process according to at least one embodiment of the present disclosure.

The computer apparatus 1, by the identification unit 101, identifies two or more subjects from the first image captured by the imaging unit (step S1). Next, the computer apparatus 1 generates, in a case where the identified two or more subjects satisfy the predetermined condition, an image obtained by superimposing the predetermined effect on the first image or the second image that is different from the first image and is captured by the imaging unit (step S2) and finishes the process.

As one aspect of the first embodiment, a program that generates new interest not existing in the related art can be provided.

In the first embodiment, for example, the “computer apparatus” refers to a stationary game console, a portable game console, a wearable terminal, a desktop or laptop personal computer, a tablet computer, or a PDA and may be a portable terminal such as a smartphone including a touch panel sensor on a display screen. For example, the “imaging unit” refers to an imaging unit having a function of capturing an image. For example, “including the imaging unit” refers to a state where an imaging function can be provided. More specifically, a case of incorporating an imaging device in the computer apparatus or communicably connecting the computer apparatus to the imaging device is exemplified. For example, the “image” is a figure, a photo, an image, graphics, or the like and may be any of a still picture or a motion picture.

In the first embodiment, for example, the “subject” refers to a target imaged by the imaging unit regardless of whether or not the target is visually recognizable. For example, the “effect” refers to visually recognizable display processing of the image. For example, “superimposition” refers to a state where overlapping of two or more objects is visually recognizable.

### Second Embodiment

A summary of a second embodiment of the present disclosure will be described. Hereinafter, a program executed in a computer apparatus including an imaging unit will be illustratively described as the second embodiment.

A content related to the configuration of the computer apparatus illustrated in FIG. 1 can be employed as necessary for a configuration of the computer apparatus in a second embodiment. A content related to the program execution process illustrated in FIG. 2 can be employed as necessary for the flowchart of the program execution process.

It is preferable that the identification unit 101 identifies a shape of each of the two or more subjects from the first image. It is preferable that in a case where the identified shape of each of the subjects satisfies the predetermined condition, the image generation unit 102 generates the image obtained by superimposing the predetermined effect on the first image or the second image that is different from the first image and is captured by the imaging unit.

As one aspect of the second embodiment, a program that generates new interest not existing in the related art can be provided.

As one aspect of the second embodiment, by generating, in a case where the identified shapes of the two or more subjects satisfy the predetermined condition, the image obtained by superimposing the predetermined effect on the first image or the second image that is different from the first image and is captured by the imaging unit, an unpredictable effect can be generated when the shapes of the subjects are combined, and interest not existing in the related art can be provided.

In the second embodiment, contents disclosed in the first embodiment can be employed as necessary for each of the “computer apparatus”, the “imaging unit”, the “including the imaging unit”, the “image”, the “subject”, the “effect”, and the “superimposition”.

In the second embodiment, for example, the “shape” refers to a state of a form of an object. Specifically, a character, a figure, a symbol, or a solid shape or a combination thereof that is visually recognizable is exemplified.

### Third Embodiment

A summary of a third embodiment of the present disclosure will be described. Hereinafter, a program executed in a computer apparatus including an imaging unit will be illustratively described as the third embodiment.

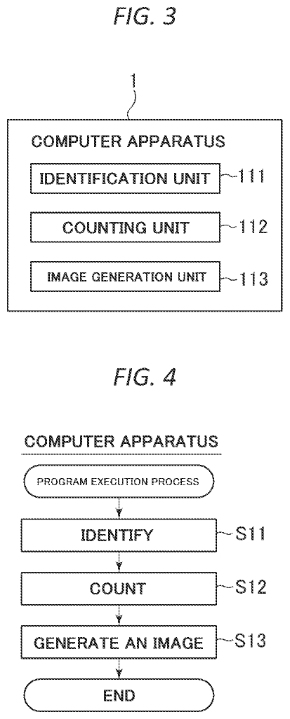

FIG. 3 is a block diagram illustrating a configuration of the computer apparatus according to at least one embodiment of the present disclosure. The computer apparatus 1 may include at least an identification unit 111, a counting unit 112, and an image generation unit 113.

The identification unit 111 has a function of identifying the shape of each of two or more subjects from the first image captured by the imaging unit. The counting unit 112 has a function of counting the number of subjects having a predetermined shape. The image generation unit 113 has a function of generating, in a case where the shapes of the two or more subjects identified by the identification unit 111 satisfy the predetermined condition, an image obtained by superimposing a predetermined effect corresponding to the counted number on the first image or the second image that is different from the first image and is captured by the imaging unit.

Next, an execution process in the third embodiment of the present disclosure will be described. FIG. 4 is a flowchart of the program execution process according to at least one embodiment of the present disclosure.

The computer apparatus 1, by the identification unit 111, identifies the shape of each of two or more subjects from the first image captured by the imaging unit (step S11). Next, the computer apparatus 1 counts the number of subjects having the predetermined shape from the identified shapes (step S12). In a case where the identified shapes of the two or more subjects satisfy the predetermined condition, the image obtained by superimposing the predetermined effect corresponding to the counted number in step S12 on the first image or the second image that is different from the first image and is captured by the imaging unit is generated (step S13), and the process is finished.

As one aspect of the third embodiment, a program that generates new interest not existing in the related art can be provided.

As one aspect of the third embodiment, by including the counting unit 112 and generating the image obtained by superimposing the predetermined effect corresponding to the counted number, an unpredictable effect can be generated when the quantity of subjects is increased or decreased, and interest not existing in the related art can be provided.

In the third embodiment, contents disclosed in the first embodiment can be employed as necessary for each of the “computer apparatus”, the “imaging unit”, the “including the imaging unit”, the “image”, the “subject”, the “effect”, and the “superimposition”.

### Fourth Embodiment

A summary of a fourth embodiment of the present disclosure will be described. Hereinafter, a program executed in a computer apparatus including an imaging unit will be illustratively described as the fourth embodiment.

Configuration of Computer Apparatus

While illustration is not provided, the computer apparatus 1, as one example, includes a control unit, a RAM, a storage unit, a sound processing unit, a graphics processing unit, the imaging unit, a communication interface, and an interface unit that are connected to each other through an internal bus. The graphics processing unit is connected to a display unit. The display unit may include a display screen and a touch input unit that receives an input by contact of a player on the display unit.

The imaging unit has a function of performing imaging through a lens. The imaging unit is connected to the control unit and the graphics processing unit and may store the captured image in the RAM or the storage unit.

The sound processing unit is connected to a sound output device that is a speaker. In a case where the control unit outputs a sound output instruction to the sound processing unit, the sound processing unit outputs a sound signal to the sound output device.

For example, the touch input unit may be able to detect a position of contact using any methods such as a resistive film method, an electrostatic capacitive method, an ultrasonic surface acoustic wave method, an optical method, or an electromagnetic induction method used in a touch panel, and any method may be used as long as an operation performed by a touch operation of the user can be recognized. The touch input unit can detect a position of a finger or the like in a case where an operation such as push or movement is performed on an upper surface of the touch input unit with the finger, a stylus, or the like.

An external memory (for example, an SD card) may be connected to the interface unit. Data read from the external memory is loaded into the RAM, and a calculation process is executed on the data by the control unit.

The communication interface can be connected to a communication network in a wireless or wired manner and can receive data through the communication network. In the same manner as the data read from the external memory, data received through the communication interface is loaded into the RAM, and the calculation process is performed on the data by the control unit.

The computer apparatus 1 may include a sensor such as a proximity sensor, an infrared sensor, a gyro sensor, or an acceleration sensor. Furthermore, the computer apparatus 1 may be an apparatus that can be mounted (wearable) on a human body. The computer apparatus 1 may be able to communicate with the display unit in a wired or wireless manner, and the display unit may be able to be mounted on the human body.

Functional Configuration of Program

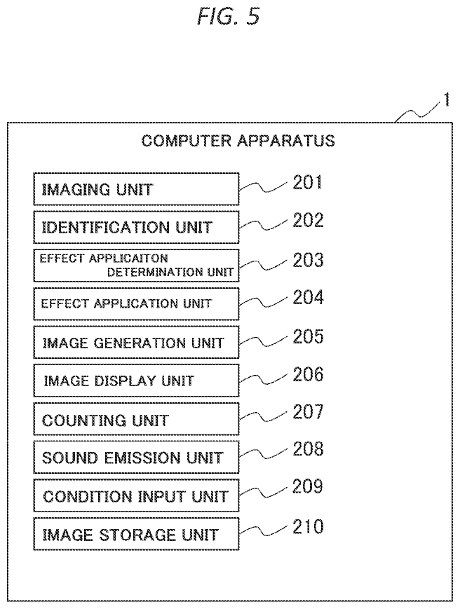

FIG. 5 is a block diagram illustrating a configuration of the computer apparatus according to at least one embodiment of the present disclosure. The computer apparatus 1 may include an imaging unit 201, an identification unit 202, an effect application determination unit 203, an effect application unit 204, an image generation unit 205, an image display unit 206, a counting unit 207, a sound emission unit 208, a condition input unit 209, and an image storage unit 210.

The imaging unit 201 has a function of imaging a real space. The identification unit 202 has a function of identifying two or more subjects from the first image captured by the imaging unit 201. The effect application determination unit 203 has a function of determining applicability to a case of applying the effect. The effect application unit 204 has a function of applying the effect to the first image or the second image that is different from the first image and is captured by the imaging unit.

The image generation unit 205 has a function of generating the image obtained by superimposing the predetermined effect on the first image or the second image that is different from the first image and is captured by the imaging unit. The image display unit 206 has a function of displaying the image generated by the image generation unit 205 on the display unit. The counting unit 207 has a function of counting the number of subjects having the predetermined shape. The sound emission unit 208 has a function of emitting a predetermined sound in a case where the identified two or more subjects satisfy a predetermined condition. The condition input unit 209 has a function of receiving an input related to the predetermined condition. The image storage unit 210 has a function of storing images captured within a predetermined period by the imaging unit 201 in a time-series order.

Summary of Program

For example, the program in the fourth embodiment is a program for identifying the shapes of two or more subjects from the first image captured by the imaging unit included in the computer apparatus and generating, in a case where the identified shape of each of the subjects satisfies the predetermined condition, the image obtained by superimposing the predetermined effect on the first image or the second image that is different from the first image and is captured by the imaging unit. More specifically, a program for generating the image obtained by superimposing the predetermined effect on the captured image based on shapes of a plurality of hand portions using hand portions of persons as the subjects will be described.

It is assumed that the computer apparatus 1 is storing an effect corresponding to the shapes of the plurality of hand portions in advance. While illustration is not provided, for example, in a case where a left palm and a right palm are identified, corresponding characters (effects) may be stored.

Program Execution Process

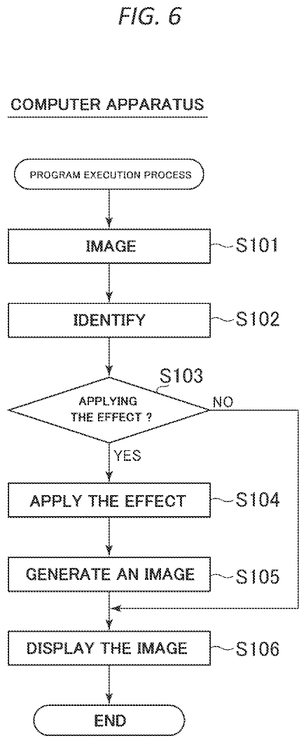

FIG. 6 is a flowchart of the program execution process according to at least one embodiment of the present disclosure. First, the computer apparatus 1 images the real space (step S101). Next, the shape of each of two or more subjects is identified from the captured image (step S102).

Next, the computer apparatus 1 determines whether or not the shape of each of the subjects identified in step S102 is applicable to the case of applying the effect (step S103). In the applicable case (YES in step S103), the computer apparatus 1 applies the effect to the captured image (step S104). Next, the computer apparatus 1 generates the image obtained by superimposing the predetermined effect on the captured image (step S105).

Next, the computer apparatus 1 displays the image generated in step S105 on the display unit (step S106) and finishes the process. In addition, in a case where the shape of each of the subjects identified in step S102 is not applicable to the case of applying the effect (NO in step S103), the captured image is not changed and is displayed on the display unit (step S106), and the process is finished.

Application of Effect (Shape)

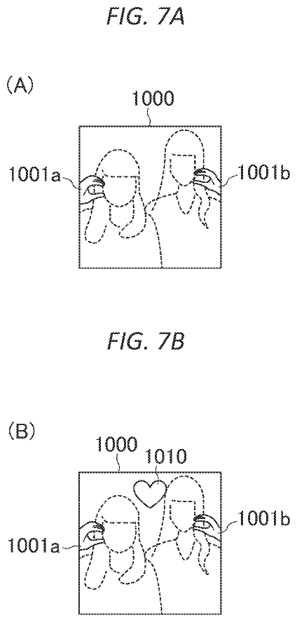

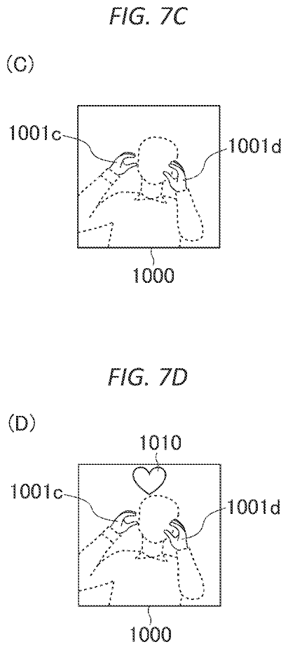

FIGS. 7A to 7D are diagrams for describing the captured image according to at least one embodiment of the present disclosure. FIG. 7A is a diagram representing an image of the real space captured in step S101. In a captured image 1000, two persons are captured, and both of the two persons are forming poses using hands.

The computer apparatus 1, by the identification unit 202, identifies fingers of persons. That is, as illustrated in FIG. 7A, a right hand 1001a of a person on the left side and a left hand 1001b of a person on the right side are identified.

In a case where the computer apparatus 1 is storing an effect to be output in association with a shape of the right hand 1001a and a shape of the left hand 1001b, an effect 1010 is applied as illustrated in FIG. 7B. The effect in the fourth embodiment may be a character, a figure, or a symbol or a combination thereof, or visually recognizable display processing such as a filter.

In the fourth embodiment, since the shape is identified, hand portions of the two persons may be identified as illustrated in FIGS. 7A and 7B, or the hand portion of one person may be identified as illustrated in FIGS. 7C and 7D. In either case, the effect 1010 is applied, and the image obtained by superimposing the effect on the original captured image is generated and displayed.

While the poses of the persons using the hand portions are described above, the present disclosure is not limited thereto. For example, any combination of a shape of clothes, a design (print or the like) of clothes, a bib that is mountable on a person, an animal, or the like and has a predetermined pattern or shape, a plurality of stuffed toys, and objects that can be mounted on a human body may be used as long as a shape thereof can be identified. In addition, the present disclosure is not limited to a combination of hand portions. That is, ways of combination are not restricted, such as a combination of a shape of a hand and a shape of clothes.

While the poses of the persons using the left and right hand portions are described above, the present disclosure is not limited thereto. For example, in a case where a predetermined number of persons forming the same pose are imaged, the image obtained by superimposing the predetermined effect may be generated.

In addition, combinations of poses are not restricted. For example, in a case where signature poses formed by five persons are registered, an image to which an explosion effect is applied may be generated in a case where poses of five persons are imaged.

In addition, even in a case where the predetermined number of persons necessary for forming the signature poses is insufficient in the signature poses, an image corresponding to an insufficient person may be displayed as the effect. For example, when there are signature poses formed by five persons, and only four persons are available, an image obtained by superimposing an image of the signature pose of the fifth person as the effect may be generated in a case where the four persons striking the respective signature poses thereof are imaged.

In addition, the captured image may be a motion picture. For example, in a case where a plurality of persons dance for 15 seconds with the same choreography, shapes of the plurality of persons may be identified. In a case where the shapes match a change in shape registered in advance, a text “GOOD” may be displayed. In a case where a non-matching scene is present, an effect of a doll performing a correct operation may be added to the video and displayed. The effect may be an image that prompts movement of positions of the subjects to correct positions.

In the above description, while the computer apparatus 1 identifies the subjects from the captured image, the present disclosure is not limited thereto. For example, the computer apparatus 1 may include, in advance, the condition input unit 209 that receives a selection of subjects and/or an effect from the user. By doing so, accuracy for identifying the subjects can be increased, and an effect preferred by the user can be mainly generated. Thus, a degree of satisfaction can be increased.

In the above description, while the computer apparatus 1 performs the determination for the subjects identified from the captured image, the present disclosure is not limited thereto. For example, a determination as to whether or not to generate the effect for a subject included in a plurality of images captured within the predetermined period may be performed. It is assumed that imaging is performed in an order of pose A→pose B→pose C within the predetermined period. It is assumed that the computer apparatus 1 is storing information for generating the predetermined effect in a case where poses are struck in an order of A, B, and C. In this case, for example, a new image to which the predetermined effect is granted can be generated in an image in which pose C is imaged.

In the above description, while the computer apparatus 1 identifies the subjects from the captured image and generates the image obtained by superimposing the predetermined effect on the same image, the present disclosure is not limited thereto. For example, the image from which the subjects are identified, and the image on which the predetermined effect is superimposed may be different images.

As one aspect of the fourth embodiment, a program that generates new interest not existing in the related art can be provided.

As one aspect of the fourth embodiment, by generating, in a case where the identified shapes of the two or more subjects satisfy the predetermined condition, the image obtained by superimposing the predetermined effect on the first image or the second image that is different from the first image and is captured by the imaging unit, an unpredictable effect can be generated when the shapes of the subjects are combined, and interest not existing in the related art can be provided.

As one aspect of the fourth embodiment, since the predetermined effect is the image that prompts movement of the positions of the subjects, the subjects can be guided, and correct positions can be intuitively understood.

In the fourth embodiment, contents disclosed in the first embodiment can be employed as necessary for each of the “computer apparatus”, the “imaging unit”, the “including the imaging unit”, the “image”, the “subject”, the “effect”, and the “superimposition”. Contents disclosed in the second embodiment can be employed as necessary for the “shape”.

### Fifth Embodiment

A summary of a fifth embodiment of the present disclosure will be described. Hereinafter, a program executed in a computer apparatus including an imaging unit will be illustratively described as the fifth embodiment.

The contents relate to the configuration of the computer apparatus in the fourth embodiment can be employed as necessary for the configuration of the computer apparatus in the fifth embodiment. The contents relate to the program function diagram in the fourth embodiment can be employed as necessary for the program function diagram in the fifth embodiment.

Summary of Program

For example, the program in the fifth embodiment is a program for identifying the shapes of two or more subjects from the first image captured by the imaging unit included in the computer apparatus, counting the number of subjects having the predetermined shape, and generating, in a case where the identified shape of each of the subjects satisfies the predetermined condition, the image obtained by superimposing the predetermined effect corresponding to the counted number on the first image or the second image that is different from the first image and is captured by the imaging unit.

More specifically, a program for generating an image obtained by superimposing, on the captured image, an effect that changes in accordance with the number of persons striking a pose of raising both hands will be described. It is assumed that the computer apparatus 1 is storing an effect corresponding to a shape of raising both hands toward the sky in advance.

Program Execution Process

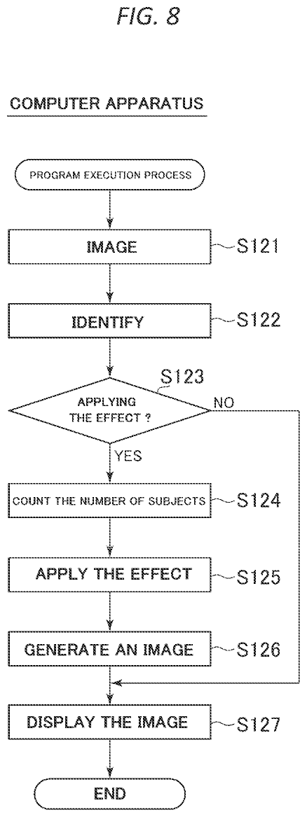

FIG. 8 is a flowchart of the program execution process according to at least one embodiment of the present disclosure. First, the computer apparatus 1 images the real space (step S121). Next, the shape of each of two or more subjects is identified from the captured first image (step S122).

Next, the computer apparatus 1 determines whether or not the shape of each of the subjects identified in step S122 is applicable to the case of applying the effect (step S123). In the applicable case (YES in step S123), the computer apparatus 1 counts the number of subjects having the predetermined shape (step S124). Next, the computer apparatus 1 applies the effect corresponding to the counted number to the first image or the second image that is different from the first image and is captured by the imaging unit (step S125).

Next, the computer apparatus 1 generates the image obtained by superimposing the predetermined effect on the captured image (step S126). Next, the computer apparatus 1 displays the image generated in step S126 on the display unit (step S127) and finishes the process. In addition, in step S123, in a case where the identified shape of each of the subjects is not applicable to the case of applying the effect (NO in step S123), the captured image is not changed and is displayed on the display unit (step S127), and the process is finished.

Application of Effect (Depending on Quantity)

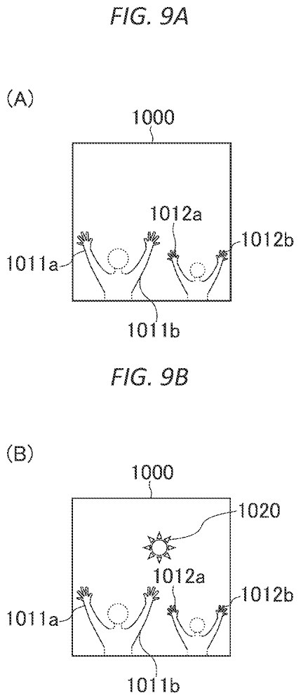

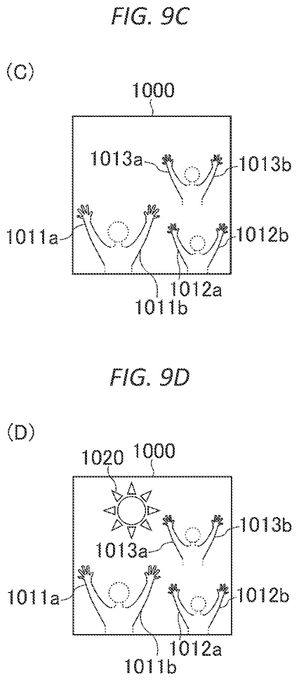

FIGS. 9A to 9D are diagrams for describing the captured image according to at least one embodiment of the present disclosure. FIG. 9A is a diagram representing an image of the real space captured in step S121. In the captured image 1000, two persons are captured, and both of the two persons are raising both hands toward the sky.

The computer apparatus 1, by the identification unit 202, identifies arm portions of persons. That is, as illustrated in FIG. 9A, a left arm 1011a and a right arm 1011b of a person on the left side and a left arm 1012a and a right arm 1012b of a person on the right side are identified.

In a case where the computer apparatus 1 is storing an effect to be output in association with a shape of raising both arms, an effect 1020 is applied as illustrated in FIG. 9B. The effect in the fifth embodiment may be a character, a figure, or a symbol or a combination thereof, or visually recognizable display processing such as a filter.

In the fifth embodiment, the shape is identified, and the effect is changed in accordance with the quantity of identified shapes. In a case where there are two persons raising both arms as illustrated in FIG. 9A, as one example, a symbol such as the sun having the size illustrated in FIG. 9B may be displayed. A shape, a color, and the like of the displayed effect are not limited as long as the displayed effect is visually recognizable. The displayed effect may be a magic bullet, a bomb a rock, or the like.

Meanwhile, in a case where there are three persons raising both arms as illustrated in FIG. 9C, a symbol such as the sun having the size illustrated in FIG. 9D may be displayed. A size of the effect 1020 may be changed in accordance with the number of persons. A color may be changed instead of the size.

In the above example, while performing counting by the counting unit after the determination performed by the effect application determination unit is described, the present disclosure is not limited thereto. That is, the determination of applicability to the case of applying the effect may be performed after counting.

In the above description, while the computer apparatus 1 identifies the subjects from the captured image and generates the image obtained by superimposing the predetermined effect on the same image, the present disclosure is not limited thereto. For example, the image from which the subjects are identified, and the image on which the predetermined effect is superimposed may be different images.

The present disclosure is not limited to the above example and may be applied to, for example, a case where students holding panels of the same color form a human character. The effect 1020 can be displayed in accordance with the number of panels.

The present disclosure is not limited to the above example and may be applied to, for example, a case of counting the number of persons crouching in a group dance and displaying the effect. Staging can be performed in real time during performance of the dance, and interest can be increased.

The present disclosure is not limited to the above example and may be applied to, for example, a case of counting the number of persons for which a predetermined costume, accessory, or belonging is mounted on the human body, and displaying the predetermined effect in a case where the number of persons is greater than or equal to a predetermined number of persons.

As one aspect of the fifth embodiment, a program that generates new interest not existing in the related art can be provided.

As one aspect of the fifth embodiment, by including the counting unit 207 and generating the image obtained by superimposing the predetermined effect corresponding to the counted number, an unpredictable effect can be generated when the quantity of subjects is increased or decreased, and interest not existing in the related art can be provided.

In the fifth embodiment, contents disclosed in the first embodiment can be employed as necessary for each of the “computer apparatus”, the “imaging unit”, the “including the imaging unit”, the “image”, the “subject”, the “effect”, and the “superimposition”.

### Sixth Embodiment

A summary of a sixth embodiment of the present disclosure will be described. Hereinafter, a program executed in a computer apparatus including an imaging unit will be illustratively described as the sixth embodiment.

The contents relate to the configuration of the computer apparatus in the fourth embodiment can be employed as necessary for the configuration of the computer apparatus in the sixth embodiment. The contents relate to the program function diagram in the fourth embodiment can be employed as necessary for the program function diagram in the sixth embodiment.

Summary of Program

For example, the program in the sixth embodiment is a program for identifying two or more subjects from the first image captured by the imaging unit included in the computer apparatus and generating, based on a positional relationship between the subjects within the captured image, the image obtained by superimposing the predetermined effect on the first image or the second image that is different from the first image and is captured by the imaging unit.

More specifically, a program for causing the identification unit to identify a reference position and head portions of persons and generating, in a case where there are many head portions in a predetermined direction of the reference position, the image obtained by superimposing the predetermined effect on the captured image will be described. It is assumed that the computer apparatus 1 is storing, in advance, information for identifying the reference position and the effect to be generated in a case where a head portion is positioned in any direction of the reference position.

Program Execution Process

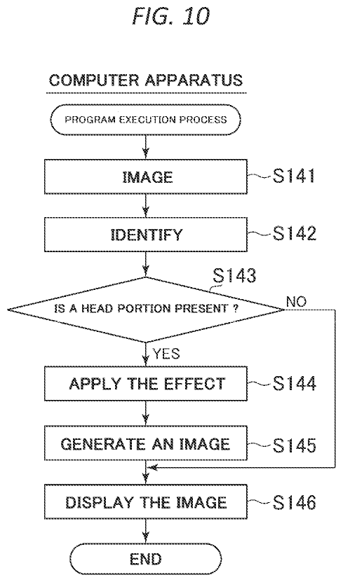

FIG. 10 is a flowchart of the program execution process according to at least one embodiment of the present disclosure. First, the computer apparatus 1 images the real space (step S141). Next, two or more subjects are identified from the captured first image (step S142). Specifically, a subject as the reference position and one or more subjects of which a positional relationship is determined are identified.

Next, the computer apparatus 1 determines whether or not a head portion is present in the predetermined direction for the subjects identified in step S142 (step S143). In a case where the head portion is present (YES in step S143), the computer apparatus 1 applies the effect to the first image (step S144).

Next, the computer apparatus 1 generates the image obtained by superimposing the predetermined effect on the first image (step S145). Next, the computer apparatus 1 displays the image generated in step S145 on the display unit (step S146) and finishes the process. In addition, in a case where the head portion is not present in the predetermined direction in step S143 (NO in step S143), the captured image is not changed and is displayed on the display unit (step S146), and the process is finished.

Application of Effect (Positional Relationship)

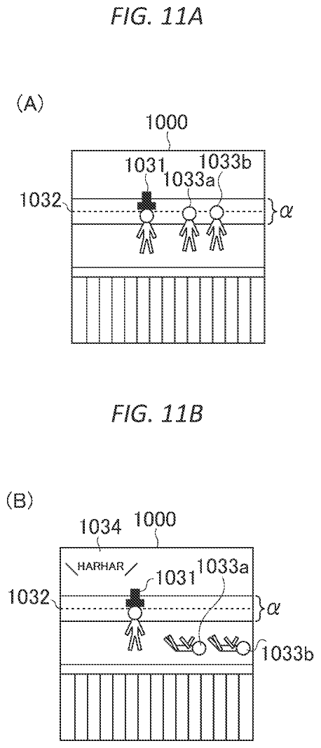

FIGS. 11A and 11B are diagrams for describing the captured image according to at least one embodiment of the present disclosure. FIG. 11A is a diagram representing an image of the real space captured in step S141. In the captured image 1000, it is assumed that three persons are captured, and one person (denoted by 1031 in FIG. 11A) is wearing a hat as a mark.

The computer apparatus 1, by the identification unit 202, identifies the reference position and head portions. That is, as illustrated in FIG. 11A, a reference person 1031 as the reference position and head portions 1033a and 1033b are identified. Specifically, a reference line 1032 is defined by identifying the reference person 1031. The reference line 1032 may be a line segment that can divide a region, or may have a region such as a width a illustrated.

In FIG. 11A, the head portions 1033a and 1033b other than the reference person 1031 are positioned within the region of the reference line 1032. In this case, in step S143, it is assumed that the head portions are not present in the predetermined direction.

It is assumed that the persons having the head portions 1033a and 1033b lie down after an elapse of time. In this case, the head portions 1033a and 1033b are positioned outside the region of the reference line 1032, and the head portions 1033a and 1033b are said to be positioned in a downward direction of the image that is the predetermined direction from the reference position.

Consequently, in a case where the computer apparatus 1 is storing an effect to be generated in a case where a head portion is positioned in the predetermined direction of the reference position, an effect 1034 is applied as illustrated in FIG. 11B. The effect in the sixth embodiment may be a character, a figure, or a symbol or a combination thereof, or visually recognizable display processing such as a filter.

In the sixth embodiment, a position as a reference and positions of other subjects are compared, and the image in which the effect is generated may be generated in a case where the compared positions have a predetermined positional relationship.

The present disclosure is not limited to the above example. For example, by using the counting unit, the effect may be generated in a case where a ratio of head portions positioned in the predetermined direction seen from the reference position is greater than or equal to a predetermined ratio.

The present disclosure is not limited to the above example and may be applied to, for example, a medical education site. For example, a plurality of organs may be used as the subjects, and an organ of a medical operation target may be used as the reference. An image showing a procedure of a medical operation may be output as the effect based on a positional relationship between the reference and the other organs. More specifically, a certain organ and a shape of a medical operation tool such as a scalpel may be identified, and an image related to a correct position or a movement trajectory of the medical operation tool may be output as the effect. In addition, shapes of the plurality of organs may be identified, and the image related to the correct position or the movement trajectory of the medical operation tool may be output as the effect.

The present disclosure is not limited to the above example and may be applied to, for example, an industrial education site. For example, the present disclosure may be applied to online teaching of a robot arm. A tip end portion of the robot arm may be used as the reference position, and an image for teaching in which direction the arm or a joint is to be moved may be output as the effect based on a positional relationship between the reference position and a supported object that is another subject.

The present disclosure is not limited to the above example and may be applied to, for example, sports. For example, the present disclosure may be applied to baseball. In a case where a position of a bat is used as the reference position, the effect may be output based on a positional relationship between the reference position and a ball that is another subject. More specifically, in a case where it is determined that the bat and the ball are hit, information for estimating a flight direction and a distance may be output, or staging of outputting an image of a firework or the like may be performed.

In the above description, while the computer apparatus 1 identifies the subjects from the captured image and generates the image obtained by superimposing the predetermined effect on the same image, the present disclosure is not limited thereto. For example, the image from which the subjects are identified, and the image on which the predetermined effect is superimposed may be different images.

As one aspect of the sixth embodiment, a program that generates new interest not existing in the related art can be provided.

As one aspect of the sixth embodiment, by generating the image obtained by superimposing the predetermined effect on the captured image based on the positional relationship between the subjects within the image, an unpredictable effect can be generated when the positions of the subjects are changed, and interest not existing in the related art can be provided.

In the sixth embodiment, contents disclosed in the first embodiment can be employed as necessary for each of the “computer apparatus”, the “imaging unit”, the “including the imaging unit”, the “image”, the “subject”, the “effect”, and the “superimposition”.

### Seventh Embodiment

Next, a summary of a seventh embodiment of the present disclosure will be described. Hereinafter, a program executed in a computer apparatus including an imaging unit and a sound output unit will be illustratively described as the seventh embodiment.

The contents relate to the configuration of the computer apparatus in the fourth embodiment can be employed as necessary for the configuration of the computer apparatus in the seventh embodiment. The contents relate to the program function diagram in the fourth embodiment can be employed as necessary for the program function diagram in the seventh embodiment.

Summary of Program

For example, the program in the seventh embodiment is a program for identifying two or more subjects from the image captured by the imaging unit included in the computer apparatus and emitting, in a case where the identified two or more subjects satisfy a predetermined condition, a predetermined sound. A content of Application of Effect (Shape) in the fourth embodiment and contents of FIGS. 7A to 7D can be employed as necessary for the condition for sound emission.

Program Execution Process

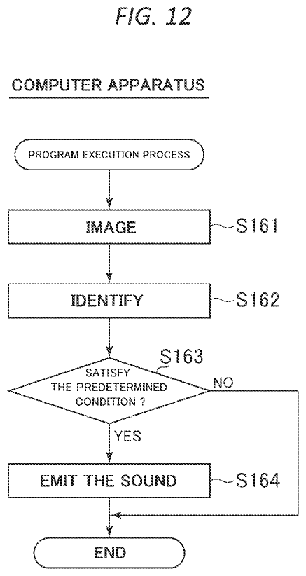

FIG. 12 is a flowchart of the program execution process according to at least one embodiment of the present disclosure. First, the computer apparatus 1 images the real space (step S161). Next, two or more subjects are identified from the captured image (step S162).

Next, the computer apparatus 1 determines whether or not the subjects identified in step S162 satisfy the predetermined condition (step S163). For example, the predetermined condition is such that all subjects have a predetermined shape, all subjects have a predetermined color, or all subjects have a predetermined pattern. Various conditions not causing contradictions may be applied without restrictions.

In a case where the predetermined condition is satisfied (YES in step S163), the computer apparatus 1 emits the sound from the sound output unit (step S164) and finishes the process. In a case where the predetermined condition is not satisfied (NO in step S163), the computer apparatus 1 finishes the process without performing any further steps.

The present disclosure is not limited to the above example. For example, instead of sound emission, the image obtained by superimposing the predetermined effect on the captured image may be generated. That is, the sound emission unit may be included in the examples of the other embodiments.

As one aspect of the seventh embodiment, a program that generates new interest not existing in the related art can be provided.

As one aspect of the seventh embodiment, by emitting the predetermined sound in a case where the identified two or more subjects satisfy the predetermined condition, an unpredictable effect can be generated, and interest not existing in the related art can be provided.

In the sixth embodiment, contents disclosed in the first embodiment can be employed as necessary for each of the “computer apparatus”, the “imaging unit”, the “including the imaging unit”, the “image”, the “subject”, the “effect”, and the “superimposition”.

### Eighth Embodiment

Next, a summary of an eighth embodiment of the present disclosure will be described. Hereinafter, a program executed in a computer apparatus including a plurality of imaging units will be illustratively described as the eighth embodiment.

The contents relate to the configuration of the computer apparatus in the fourth embodiment can be employed as necessary for the configuration of the computer apparatus in the eighth embodiment. The contents relate to the program function diagram in the fourth embodiment can be employed as necessary for the program function diagram in the eighth embodiment.

Summary of Program

For example, the program in the eighth embodiment is a program for identifying two or more subjects from one or more images among a plurality of images captured by the plurality of imaging units included in the computer apparatus and generating, in a case where the identified two or more subjects satisfy the predetermined condition, an image obtained by superimposing the predetermined effect on any captured image or one or more images that are different from the any captured image among the images captured by the plurality of imaging units.

More specifically, as one example, a program that is executed in a portable terminal apparatus including two cameras capable of imaging the front and the back of the portable terminal apparatus and is a program for generating an image obtained by superimposing the predetermined effect on a captured image based on shapes of a plurality of hand portions using hand portions of persons as the subjects will be described. It is assumed that the computer apparatus 1 is storing an effect corresponding to the shapes of the plurality of hand portions in advance.

Program Execution Process

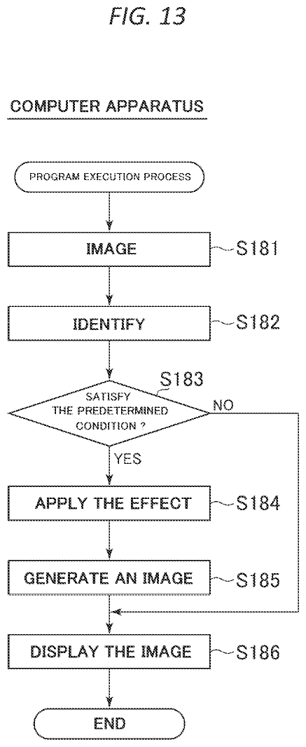

FIG. 13 is a flowchart of the program execution process according to at least one embodiment of the present disclosure. First, the computer apparatus 1 images the real space by the plurality of imaging units (step S181). Next, two or more subjects are identified from one or more images among the plurality of captured images (step S182).

Next, the computer apparatus 1 determines whether or not the two or more subjects identified in step S182 satisfy the predetermined condition (step S183). In a case where the predetermined condition is satisfied (YES in step S183), the computer apparatus 1 applies the predetermined effect to any captured image or one or more images that are different from the any captured image among the images captured by the plurality of imaging units (step S184). For example, the predetermined condition is such that all subjects have a predetermined shape, all subjects have a predetermined color, or all subjects have a predetermined pattern. Various conditions not causing contradictions may be applied without restrictions.

Next, the computer apparatus 1 generates the image obtained by superimposing the predetermined effect (step S185). Next, the computer apparatus 1 displays the image generated in step S185 on the display unit (step S186) and finishes the process. In addition, in a case where the predetermined condition is not satisfied in step S183 (NO in step S183), the captured image is not changed and is displayed on the display unit (step S186), and the process is finished.

Application of Effect (Shape) (Part 2)

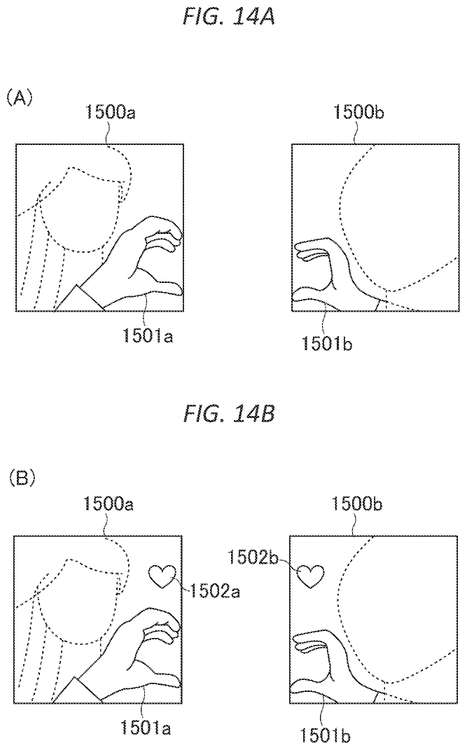

FIGS. 14A and 14B are diagrams for describing the captured images according to at least one embodiment of the present disclosure. FIG. 14A is a diagram representing the plurality of images of the real space captured in step S181. As one example, one person is captured in each of captured images 1500a and 1500b, and a hand portion is forming a predetermined shape (half of a heart).

The computer apparatus 1, by the identification unit 202, identifies hand portions of persons. That is, as illustrated in FIG. 14A, a right hand 1501a of a person in the image 1500a and a left hand 1501b of a person in the image 1500b are identified.

In a case where the computer apparatus 1 is storing an effect to be output in association with a shape of the right hand 1501a and a shape of the left hand 1501b, effects 1502a and 1502b are applied as illustrated in FIG. 14B. The effect to be output may be any one of the effect 1502a or 1502b. The effect in the eighth embodiment may be a character, a figure, or a symbol or a combination thereof, or visually recognizable display processing such as a filter.

While the poses of the persons using the hand portions are described above, the present disclosure is not limited thereto. For example, any combination of a shape of clothes, a design (print or the like) of clothes, a bib that is mountable on a person, an animal, or the like and has a predetermined pattern or shape, a plurality of stuffed toys, and objects that can be mounted on a human body may be used as long as a shape thereof can be identified. In addition, the present disclosure is not limited to a combination of hand portions. That is, ways of combination are not restricted, such as a combination of a shape of a hand and a shape of clothes.

While the poses of the persons using the left and right hand portions are described above, the present disclosure is not limited thereto. For example, in a case where a predetermined number of persons forming the same pose are imaged by the plurality of imaging units, the image obtained by superimposing the predetermined effect may be generated.

In the above description, while the computer apparatus 1 identifies the subjects from the plurality of captured images, the present disclosure is not limited thereto. For example, the computer apparatus 1 may include, in advance, the condition input unit 209 that receives a selection of subjects and/or an effect from the user. By doing so, accuracy for identifying the subjects can be increased, and the effect preferred by the user can be mainly generated. Thus, the degree of satisfaction can be increased.

In the above description, while the computer apparatus 1 identifies the subjects from any captured image and generates the image obtained by superimposing the predetermined effect on the same image, the present disclosure is not limited thereto. For example, the image from which the subjects are identified, and the image on which the predetermined effect is superimposed may be different images.

As one aspect of the eighth embodiment, a program that generates new interest not existing in the related art can be provided.

As one aspect of the eighth embodiment, by generating, in a case where the identified shapes of the two or more subjects satisfy the predetermined condition, the image obtained by superimposing the predetermined effect on any captured image or one or more images that are different from the any captured image among the images captured by the plurality of imaging units, an unpredictable effect can be generated when the shapes of the subjects are combined, and interest not existing in the related art can be provided.

In the eighth embodiment, contents disclosed in the first embodiment can be employed as necessary for each of the “computer apparatus”, the “imaging unit”, the “including the imaging unit”, the “image”, the “subject”, the “effect”, and the “superimposition”. Contents disclosed in the second embodiment can be employed as necessary for the “shape”.

### Ninth Embodiment

A summary of a ninth embodiment of the present disclosure will be described. Hereinafter, as the ninth embodiment, a system including a terminal apparatus including an imaging unit and a server apparatus connectable to the terminal apparatus by communication will be illustratively described.

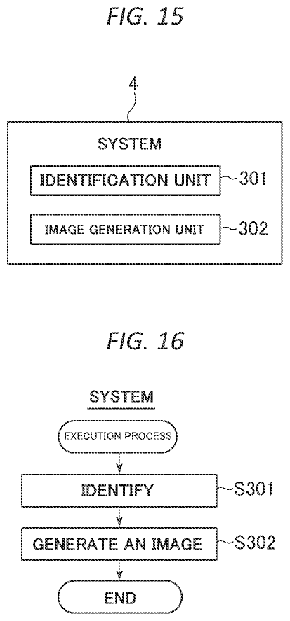

FIG. 15 is a block diagram illustrating a configuration of the system according to at least one embodiment of the present disclosure. A system 4 includes at least an identification unit 301 and an image generation unit 302.

The identification unit 301 has a function of identifying two or more subjects from a first image captured by the imaging unit. The image generation unit 302 has a function of generating, in a case where the two or more subjects identified by the identification unit 301 satisfy a predetermined condition, an image obtained by superimposing a predetermined effect on the first image or a second image that is different from the first image and is captured by the imaging unit.

Next, an execution process in the ninth embodiment of the present disclosure will be described. FIG. 16 is a flowchart of the execution process according to at least one embodiment of the present disclosure.

The system 4, by the identification unit 301, identifies two or more subjects from the first image captured by the imaging unit (step S301). Next, the system 4 generates, in a case where the identified two or more subjects satisfy the predetermined condition, an image obtained by superimposing the predetermined effect on the first image or the second image that is different from the first image and is captured by the imaging unit (step S302) and finishes the process.

As one aspect of the ninth embodiment, a program that generates new interest not existing in the related art can be provided.

In the ninth embodiment, contents disclosed in the first embodiment can be employed as necessary for each of the “imaging unit”, the “including the imaging unit”, the “image”, the “subject”, the “effect”, and the “superimposition”. Contents disclosed in the second embodiment can be employed as necessary for the “shape”.

In the ninth embodiment, for example, the “terminal apparatus” refers to a stationary game console, a portable game console, a wearable terminal, a desktop or laptop personal computer, a tablet computer, or a PDA and may be a portable terminal such as a smartphone including a touch panel sensor on a display screen. For example, the “server apparatus” refers to an apparatus that executes a process in accordance with a request from the terminal apparatus.

### Tenth Embodiment

A summary of a tenth embodiment of the present disclosure will be described. Hereinafter, as the tenth embodiment, a system including a terminal apparatus including an imaging unit and a server apparatus connectable to the terminal apparatus by communication will be illustratively described.

The contents relate to the configuration of the computer apparatus in the fourth embodiment can be employed as necessary for the configuration of the terminal apparatus in the tenth embodiment.

Configuration of System

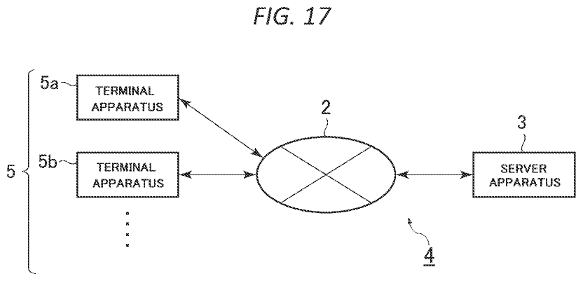

FIG. 17 is a block diagram illustrating a configuration of the system according to at least one embodiment of the present disclosure. As illustrated, the system 4 is configured with a plurality of terminal apparatuses 5 (terminal apparatuses 5a, 5b, . . . ) operated by a plurality of users (users A, B, . . . ), a communication network 2, and a server apparatus 3. The terminal apparatuses 5 are connected to the server apparatus 3 through the communication network 2. The terminal apparatuses 5 and the server apparatus 3 may not be connected at all times, and the connection may be available as necessary.

The server apparatus 3 includes at least a control unit, a RAM, a storage unit, and a communication interface that are connected to each other through an internal bus. The control unit may include an internal timer. In addition, the control unit may synchronize with an external server using the communication interface. Accordingly, the real time may be acquired.

Functional Configuration of System

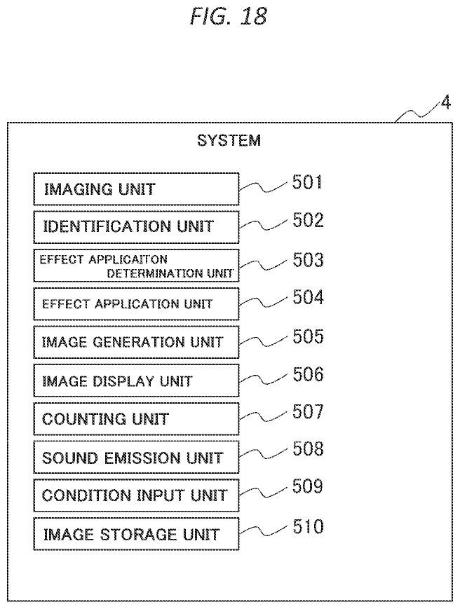

FIG. 18 is a block diagram illustrating a configuration of the system according to at least one embodiment of the present disclosure. The system 4 may include an imaging unit 501, an identification unit 502, an effect application determination unit 503, an effect application unit 504, an image generation unit 505, an image display unit 506, a counting unit 507, a sound emission unit 508, a condition input unit 509, and an image storage unit 510.

The imaging unit 501 has a function of imaging a real space. The identification unit 502 has a function of identifying two or more subjects from the first image captured by the imaging unit 501. The effect application determination unit 503 has a function of determining applicability to a case of applying the effect. The effect application unit 504 has a function of applying the effect to the first image or the second image that is different from the first image and is captured by the imaging unit.

The image generation unit 505 has a function of generating the image obtained by superimposing the predetermined effect on the first image or the second image that is different from the first image and is captured by the imaging unit. The image display unit 506 has a function of displaying the image generated by the image generation unit 505 on the display unit. The counting unit 507 has a function of counting the number of subjects having the predetermined shape. The sound emission unit 508 has a function of emitting a predetermined sound in a case where the identified two or more subjects satisfy a predetermined condition. The condition input unit 509 has a function of receiving an input related to the predetermined condition. The image storage unit 510 has a function of storing images captured within a predetermined period by the imaging unit 501 in a time-series order.

Summary of System

For example, the system in the tenth embodiment is a system for identifying two or more subjects from the first image captured by the imaging unit included in the terminal apparatus 5 and generating, in a case where the identified two or more subjects satisfy the predetermined condition, the image obtained by superimposing the predetermined effect on the first image or the second image that is different from the first image and is captured by the imaging unit.

More specifically, a system for generating the image obtained by superimposing the predetermined effect on the captured image based on shapes of a plurality of hand portions using hand portions of persons as the subjects will be described. It is assumed that the system 4 is storing an effect corresponding to the shapes of the plurality of hand portions in advance.

Execution Process

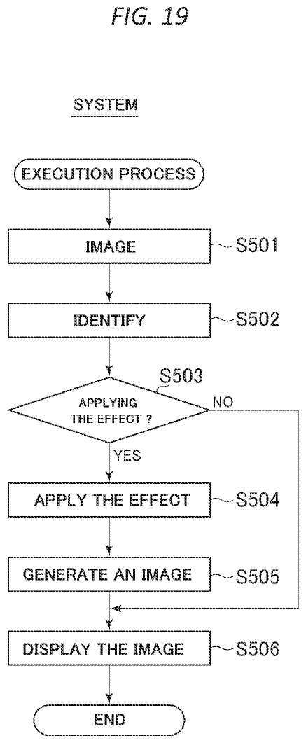

FIG. 19 is a flowchart of the execution process according to at least one embodiment of the present disclosure. First, the system 4 captures the real space by the imaging unit (step S501). Next, two or more subjects are identified from the captured image (step S502).

Next, the system 4 determines whether or not the two or more subjects identified in step S502 satisfy the predetermined condition (step S503). In a case where the predetermined condition is satisfied (YES in step S503), the system 4 applies the predetermined effect to the captured image (step S504). For example, the predetermined condition is such that all subjects have a predetermined shape, all subjects have a predetermined color, or all subjects have a predetermined pattern. Various conditions not causing contradictions may be applied without restrictions.

Next, the system 4 generates the image obtained by superimposing the predetermined effect (step S505). Next, the system 4 displays the image generated in step S505 on the display unit (step S506) and finishes the process. In addition, in a case where the predetermined condition is not satisfied in step S503 (NO in step S503), the captured image is not changed and is displayed on the display unit (step S506), and the process is finished.

The content illustrated in Application of Effect (Shape) in the fourth embodiment and the contents illustrated in FIGS. 7A to 7D can be employed as necessary for application of the effect in the tenth embodiment.

While the poses of the persons using the hand portions are described above, the present disclosure is not limited thereto. For example, any combination of a shape of clothes, a design (print or the like) of clothes, a bib that is mountable on a person, an animal, or the like and has a predetermined pattern or shape, a plurality of stuffed toys, and objects that can be mounted on a human body may be used as long as a shape thereof can be identified. In addition, the present disclosure is not limited to a combination of hand portions. That is, ways of combination are not restricted, such as a combination of a shape of a hand and a shape of clothes.

While the poses of the persons using the left and right hand portions are described above, the present disclosure is not limited thereto. For example, in a case where a predetermined number of persons forming the same pose are imaged by the plurality of imaging units, the image obtained by superimposing the predetermined effect may be generated.

In the above description, while the system 4 identifies the subjects from the plurality of captured images, the present disclosure is not limited thereto. For example, the system 4 may include, in advance, the condition input unit 509 that receives a selection of subjects and/or an effect from the user. By doing so, accuracy for identifying the subjects can be increased, and the effect preferred by the user can be mainly generated. Thus, the degree of satisfaction can be increased.

In the above description, while the system 4 identifies the subjects from the captured image and generates the image obtained by superimposing the predetermined effect on the same image, the present disclosure is not limited thereto. For example, the image from which the subjects are identified, and the image on which the predetermined effect is superimposed may be different images.

As one aspect of the tenth embodiment, a program that generates new interest not existing in the related art can be provided.

As one aspect of the tenth embodiment, by generating, in a case where the identified shapes of the two or more subjects satisfy the predetermined condition, the image obtained by superimposing the predetermined effect on the captured image, an unpredictable effect can be generated when the shapes of the subjects are combined, and interest not existing in the related art can be provided.

In the tenth embodiment, contents disclosed in the first embodiment can be employed as necessary for each of the “imaging unit”, the “including the imaging unit”, the “image”, the “subject”, the “effect”, and the “superimposition”. Contents disclosed in the second embodiment can be employed as necessary for the “shape”. Contents disclosed in the ninth embodiment can be employed as necessary for the “terminal apparatus” and the “server apparatus”.

### Eleventh Embodiment

Next, a summary of an eleventh embodiment of the present disclosure will be described. Hereinafter, as the eleventh embodiment, a system including a plurality of terminal apparatuses including imaging units and a server apparatus connectable to the terminal apparatuses by communication will be illustratively described.

The contents relate to the configuration of the system in the tenth embodiment can be employed as necessary for the configuration of the system in the eleventh embodiment. The contents relate to the configuration of the system function in the tenth embodiment can be employed as necessary for the configuration of the system function in the eleventh embodiment.

Summary of System

For example, the system in the eleventh embodiment is a system for identifying two or more subjects from one or more images among a plurality of images captured by the imaging units included in the plurality of terminal apparatuses and generating, in a case where the identified two or more subjects satisfy the predetermined condition, an image obtained by superimposing the predetermined effect on any captured image or one or more images that are different from the any captured image among the images captured by the imaging units of the plurality of terminal apparatuses. That is, the system concentrates the images captured by the imaging units of the plurality of terminal apparatuses present at positions separated from each other in the server apparatus 3 through the communication network 2 and generates a new image to which the predetermined effect is applied.

More specifically, as one example, a system for generating the image obtained by superimposing the predetermined effect on the captured image based on shapes of a plurality of hand portions using hand portions of persons as the subjects will be described. It is assumed that the system 4 is storing an effect corresponding to the shapes of the plurality of hand portions in advance.

Execution Process

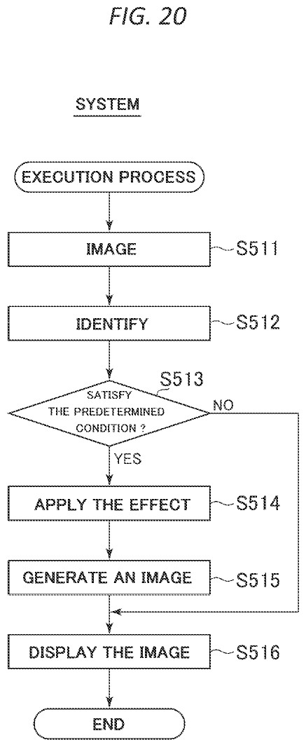

FIG. 20 is a flowchart of the execution process according to at least one embodiment of the present disclosure. First, the system 4 captures the real space by the imaging units of the plurality of terminal apparatuses (step S511). Next, two or more subjects are identified from one or more images among the plurality of captured images (step S512).

Next, the system 4 determines whether or not the two or more subjects identified in step S512 satisfy the predetermined condition (step S513). In a case where the predetermined condition is satisfied (YES in step S513), the system 4 applies the predetermined effect to any captured image or one or more images that are different from the any captured image among the images captured by the imaging units of the plurality of terminal apparatuses (step S514). For example, the predetermined condition is such that all subjects have a predetermined shape, all subjects have a predetermined color, or all subjects have a predetermined pattern. Various conditions not causing contradictions may be applied without restrictions.

Next, the system 4 generates the image obtained by superimposing the predetermined effect (step S515). Next, the system 4 displays the image generated in step S515 on the display unit (step S516) and finishes the process. In addition, in a case where the predetermined condition is not satisfied in step S513 (NO in step S513), the captured image is not changed and is displayed on the display unit (step S516), and the process is finished.

Application of Effect (Shape Part 2) illustrated in the eighth embodiment and contents illustrated in FIGS. 14A and 14B can be employed as necessary for a content related to application of the effect in the eleventh embodiment.

While the poses of the persons using the hand portions are described above, the present disclosure is not limited thereto. For example, any combination of a shape of clothes, a design (print or the like) of clothes, a bib that is mountable on a person, an animal, or the like and has a predetermined pattern or shape, a plurality of stuffed toys, and objects that can be mounted on a human body may be used as long as a shape thereof can be identified. In addition, the present disclosure is not limited to a combination of hand portions. That is, ways of combination are not restricted, such as a combination of a shape of a hand and a shape of clothes.

While the poses of the persons using the left and right hand portions are described above, the present disclosure is not limited thereto. For example, in a case where a predetermined number of persons forming the same pose are imaged by the plurality of imaging units, the image obtained by superimposing the predetermined effect may be generated.

In the above description, while the system 4 identifies the subjects from the plurality of captured images, the present disclosure is not limited thereto. For example, the system 4 may include, in advance, the condition input unit 509 that receives a selection of subjects and/or an effect from the user. By doing so, accuracy for identifying the subjects can be increased, and an effect preferred by the user can be mainly generated. Thus, a degree of satisfaction can be increased.

In the above example, while description is provided using hand portions of persons, the present disclosure is not limited thereto. For example, the present disclosure may be applied to a swimming competition held at different swimming race venues. In each swimming race venue, the terminal apparatuses 5 image a shape of a pool and swimming race competitors. The captured images are transmitted to the server apparatus 3. The server apparatus 3 may identify the shape of the pool and the swimming race competitors from a plurality of gathered images and display a ghost image of the swimming race competitors in a superimposed manner on any captured image. That is, the same competition can be held without gathering the competitors, and an image can be provided to the user such that all swimming race competitors are gathered.

In the above description, while the system 4 identifies the subjects from the captured image and generates the image obtained by superimposing the predetermined effect on the same image, the present disclosure is not limited thereto. For example, the image from which the subjects are identified, and the image on which the predetermined effect is superimposed may be different images.

As one aspect of the eleventh embodiment, a program that generates new interest not existing in the related art can be provided.

As one aspect of the eleventh embodiment, by generating, in a case where the identified shapes of the two or more subjects satisfy the predetermined condition, the image obtained by superimposing the predetermined effect on the captured image, an unpredictable effect can be generated when the shapes of the subjects are combined, and interest not existing in the related art can be provided.

As one aspect of the eleventh embodiment, by identifying two or more subjects from the plurality of images captured by the imaging units of the plurality of terminal apparatuses and generating, in a case where the identified two or more subjects satisfy the predetermined condition, the image obtained by superimposing the predetermined effect on any captured image, an unpredictable effect can be generated when images of separated locations are combined with each other, and interest not existing in the related art can be provided.

In the eleventh embodiment, contents disclosed in the first embodiment can be employed as necessary for each of the “imaging unit”, the “including the imaging unit”, the “image”, the “subject”, the “effect”, and the “superimposition”. Contents disclosed in the second embodiment can be employed as necessary for the “shape”. Contents disclosed in the ninth embodiment can be employed as necessary for the “terminal apparatus” and the “server apparatus”.

### Twelfth Embodiment

A summary of a twelfth embodiment of the present disclosure will be described. Hereinafter, a program executed in a computer apparatus including an imaging unit and an input unit including a microphone or a receiver will be illustratively described as the twelfth embodiment.

The contents relate to the configuration of the computer apparatus in the first embodiment and the contents shown in FIG. 1 can be employed as necessary for the configuration of the computer apparatus in the twelfth embodiment. The contents relate to the program execution process in the first embodiment and the contents shown in FIG. 2 can be employed as necessary for the program execution process in the twelfth embodiment.

The identification unit has a function of identifying two or more targets from an input provided by the input unit. The image generation unit has a function of generating, in a case where the identified two or more targets satisfy the predetermined condition, the image obtained by superimposing the predetermined effect on the image captured by the imaging unit.

In the above description, while an example of identifying two or more targets from the input provided by the input unit is exemplified, the present disclosure is not limited thereto. For example, the image captured by the imaging unit and a sound input by the input unit may be identified, and the predetermined effect may be output in a superimposed manner. That is, the input may be in a form other than image information provided by the imaging unit. For example, the predetermined effect may be generated by identifying information received by the receiver and ambient voice in combination.

As one aspect of the twelfth embodiment, a program that generates new interest not existing in the related art can be provided.

In the twelfth embodiment, contents disclosed in the first embodiment can be employed as necessary for each of the “computer apparatus”, the “imaging unit”, the “including the imaging unit”, the “image”, the “subject”, the “effect”, and the “superimposition”.

### Thirteenth Embodiment

A summary of a thirteenth embodiment of the present disclosure will be described. Hereinafter, a program executed in a computer apparatus including an imaging unit and an input unit including a microphone or a receiver will be illustratively described as the thirteenth embodiment.

The contents relate to the configuration of the system in the ninth embodiment and the contents shown in FIG. 15 can be employed as necessary for the configuration of the system in the thirteenth embodiment. The contents relate to the execution process in the ninth embodiment and the contents shown in FIG. 16 can be employed as necessary for the execution process in the thirteenth embodiment.

The identification unit has a function of identifying two or more targets from an input provided by the input unit. The image generation unit has a function of generating, in a case where the identified two or more targets satisfy the predetermined condition, the image obtained by superimposing the predetermined effect on the image captured by the imaging unit.

In the above description, while an example of identifying two or more targets from the input provided by the input unit is exemplified, the present disclosure is not limited thereto. For example, the image captured by the imaging unit and a sound input by the input unit may be identified, and the predetermined effect may be output in a superimposed manner. That is, the input may be in a form other than image information provided by the imaging unit. For example, the predetermined effect may be generated by identifying information received by the receiver and ambient voice in combination.

As one aspect of the thirteenth embodiment, a program that generates new interest not existing in the related art can be provided.

In the thirteenth embodiment, contents disclosed in the first embodiment can be employed as necessary for each of the “imaging unit”, the “including the imaging unit”, the “image”, the “subject”, the “effect”, and the “superimposition”.

### APPENDIX

The above embodiments have been described such that the following disclosure can be embodied by those who have ordinary knowledge in the field to which the disclosure belongs.

(1) A program executed in a computer apparatus including an imaging unit, the program causing the computer apparatus to implement:

an identification function of identifying two or more subjects from a first image captured by the imaging unit, and

an image generation function of generating, in a case where the identified two or more subjects satisfy a predetermined condition, an image obtained by superimposing a predetermined effect on the first image or a second image that is different from the first image and is captured by the imaging unit.

(2) The program according to (1), in which in the identification function, a shape of each of the two or more subjects is identified from the first image, and in the image generation function, in a case where the identified shape of each of the subjects satisfies the predetermined condition, the image obtained by superimposing the predetermined effect on the first image or the second image that is different from the first image and is captured by the imaging unit is generated.

(3) The program according to (1) or (2), in which in the identification function, a shape of each of the two or more subjects is identified from the first image, the program further causes the computer apparatus to implement

a counting function of counting the number of subjects having a predetermined shape, and

in the image generation function, in a case where the identified shapes of the two or more subjects satisfy the predetermined condition, an image obtained by superimposing a predetermined effect corresponding to the counted number on the first image or the second image that is different from the first image and is captured by the imaging unit is generated.

(4) The program according to any one of (1) to (3), in which in the image generation function, the image obtained by superimposing the predetermined effect on the first image or the second image that is different from the first image and is captured by the imaging unit is generated based on a positional relationship between the subjects within the image.

(5) The program according to any one of (1) to (4), in which the computer apparatus includes a sound output unit, and the program further causes the computer apparatus to implement a sound emission function of emitting a predetermined sound in a case where the identified two or more subjects satisfy the predetermined condition.

(6) The program according to any one of (1) to (5),

in which the computer apparatus includes a plurality of the imaging units,

in the identification function, two or more subjects are identified from one or more images among a plurality of images captured by the plurality of imaging units, and

in the image generation function, in a case where the identified two or more subjects satisfy the predetermined condition, an image obtained by superimposing the predetermined effect on any captured image or one or more images that is different from the any captured image among the images captured by the plurality of imaging units is generated.

(7) The program according to any one of (1) to (6), in which the predetermined effect is an image that prompts movement of positions of the subjects.

(8) The program according to any one of (1) to (7), in which the subjects are objects mountable on a person.

(9) The program according to any one of (1) to (8), further causing the computer apparatus to implement:

an image storage function of storing images captured within a predetermined period by the imaging unit in a time-series order,

in which in the image generation function, in a case where the identified two or more subjects satisfy the predetermined condition in one or more images among a plurality of stored images, an image obtained by superimposing the predetermined effect on the stored image or an image that is different from the stored image and is captured by the imaging unit is generated.

(10) The program according to any one of (1) to (9), further causing the computer apparatus to implement a condition input function of receiving an input related to the predetermined condition.

(11) A computer apparatus on which the program according to any one of (1) to (10) is installed.

(12) A control method executed in a computer apparatus including an imaging unit, the control method including:

a step of identifying two or more subjects from a first image captured by the imaging unit, and

a step of generating, in a case where the identified two or more subjects satisfy a predetermined condition, an image obtained by superimposing a predetermined effect on the first image or a second image that is different from the first image and is captured by the imaging unit.

(13) A program executed in a server apparatus in a system including a terminal apparatus including an imaging unit, and the server apparatus connectable to the terminal apparatus by communication, the program causing the server apparatus to implement:

an identification function of identifying two or more subjects from a first image captured by the imaging unit, and

an image generation function of generating, in a case where the identified two or more subjects satisfy a predetermined condition, an image obtained by superimposing a predetermined effect on the first image or a second image that is different from the first image and is captured by the imaging unit.

(14) The program according to (13), in which the system includes a plurality of the terminal apparatuses, in the identification function, two or more subjects are identified from one or more images among a plurality of images captured by the imaging units of the plurality of terminal apparatuses, and in the image generation function, in a case where the identified two or more subjects satisfy the predetermined condition, an image obtained by superimposing the predetermined effect on any captured image or one or more images that is different from the any captured image among the images captured by the imaging units of the plurality of terminal apparatuses is generated.

(15) A server apparatus on which the program according to (13) or (14) is installed.

(16) A system including a terminal apparatus including an imaging unit, and a server apparatus connectable to the terminal apparatus by communication, the system having an identification function of identifying two or more subjects from a first image captured by the imaging unit, and an image generation function of generating, in a case where the identified two or more subjects satisfy a predetermined condition, an image obtained by superimposing a predetermined effect on the first image or a second image that is different from the first image and is captured by the imaging unit.

(17) A program executed in a terminal apparatus in a system including the terminal apparatus including an imaging unit, and a server apparatus connectable to the terminal apparatus by communication, the program causing the terminal apparatus to implement:

an identification function of identifying two or more subjects from a first image captured by the imaging unit, and

an image generation function of generating, in a case where the identified two or more subjects satisfy a predetermined condition, an image obtained by superimposing a predetermined effect on the first image or a second image that is different from the first image and is captured by the imaging unit.

(18) A terminal apparatus on which the program according to (17) is installed.

(19) A control method executed in a server apparatus in a system including a terminal apparatus including an imaging unit, and the server apparatus connectable to the terminal apparatus by communication, the control method including:

a step of identifying two or more subjects from a first image captured by the imaging unit, and

a step of generating, in a case where the identified two or more subjects satisfy a predetermined condition, an image obtained by superimposing a predetermined effect on the first image or a second image that is different from the first image and is captured by the imaging unit.

(20) A control method executed in a system including a terminal apparatus including an imaging unit, and a server apparatus connectable to the terminal apparatus by communication, the control method including:

a step of identifying two or more subjects from a first image captured by the imaging unit, and

a step of generating, in a case where the identified two or more subjects satisfy a predetermined condition, an image obtained by superimposing a predetermined effect on the first image or a second image that is different from the first image and is captured by the imaging unit.

(21) A program executed in a computer apparatus including an imaging unit and an input unit including a microphone or a receiver, the program causing the computer apparatus to implement:

an identification function of identifying two or more targets from an input provided by the input unit, and

an image generation function of generating, in a case where the identified two or more targets satisfy a predetermined condition, an image obtained by superimposing a predetermined effect on an image captured by the imaging unit.

(22) A computer apparatus including an imaging unit and an input unit including a microphone or a receiver, the computer apparatus including:

an identification unit that identifies two or more targets from an input provided by the input unit, and

an image generation unit that generates, in a case where the identified two or more targets satisfy a predetermined condition, an image obtained by superimposing a predetermined effect on an image captured by the imaging unit.

(23) A control method executed in a computer apparatus including an imaging unit and an input unit including a microphone or a receiver, the control method including:

a step of identifying two or more targets from an input provided by the input unit, and

a step of generating, in a case where the identified two or more targets satisfy a predetermined condition, an image obtained by superimposing a predetermined effect on an image captured by the imaging unit.

(24) A program executed in a server apparatus in a system including a terminal apparatus including an imaging unit and an input unit including a microphone or a receiver, and the server apparatus connectable to the terminal apparatus by communication, the program causing the server apparatus to implement:

an identification function of identifying two or more targets from an input provided by the input unit, and

an image generation function of generating, in a case where the identified two or more targets satisfy a predetermined condition, an image obtained by superimposing a predetermined effect on an image captured by the imaging unit.

(25) A server apparatus on which the program according to (24) is installed.

(26) A system including a terminal apparatus including an imaging unit and an input unit including a microphone or a receiver, and a server apparatus connectable to the terminal apparatus by communication, the system including:

an identification unit that identifies two or more targets from an input provided by the input unit, and

an image generation unit that generates, in a case where the identified two or more targets satisfy a predetermined condition, an image obtained by superimposing a predetermined effect on an image captured by the imaging unit.

(27) A program executed in a terminal apparatus in a system including the terminal apparatus including an imaging unit and an input unit including a microphone or a receiver, and a server apparatus connectable to the terminal apparatus by communication, the program causing the terminal apparatus to implement:

an identification function of identifying two or more targets from an input provided by the input unit, and

an image generation function of generating, in a case where the identified two or more targets satisfy a predetermined condition, an image obtained by superimposing a predetermined effect on an image captured by the imaging unit.

(28) A terminal apparatus on which the program according to (27) is installed.

(29) A control method executed in a server apparatus in a system including a terminal apparatus including an imaging unit and an input unit including a microphone or a receiver, and the server apparatus connectable to the terminal apparatus by communication, the control method including:

a step of identifying two or more targets from an input provided by the input unit, and

a step of generating, in a case where the identified two or more targets satisfy a predetermined condition, an image obtained by superimposing a predetermined effect on an image captured by the imaging unit.

(30) A control method executed in a system including a terminal apparatus including an imaging unit and an input unit including a microphone or a receiver, and a server apparatus connectable to the terminal apparatus by communication, the control method including:

a step of identifying two or more targets from an input provided by the input unit, and

a step of generating, in a case where the identified two or more targets satisfy a predetermined condition, an image obtained by superimposing a predetermined effect on an image captured by the imaging unit.

### REFERENCE SIGNS LIST

1 COMPUTER APPARATUS
2 COMMUNICATION NETWORK
3 SERVER APPARATUS
4 SYSTEM
5 TERMINAL APPARATUS

1. A non-transitory computer-readable recording medium having recorded thereon a program executed in a computer apparatus, the program causing the computer apparatus to perform functions comprising:
identifying two or more subjects in a first image from an imaging device; and
if the identified two or more subjects satisfy a predetermined condition, superimposing a predetermined effect either on the first image or on a second image from the imaging device that is different from the first image to generate a third image and providing the third image.

2. The non-transitory computer-readable recording medium having recorded thereon the program according to claim 1,
wherein identifying the two or more objects comprises identifying each shape of each of the two or more subjects in the first image, and
wherein if the identified shape of each of the subjects satisfies the predetermined condition, superimposing a predetermined effect either on the first image or on the second image to generate the third image.

3. The non-transitory computer-readable recording medium having recorded thereon the program according to claim 1,
wherein identifying the two or more objects comprises identifying each shape of each of the two or more subjects in the first image,
wherein the functions further comprise counting a number of the two or more subjects having a predetermined shape, and
wherein the predetermined effect corresponds to the counted number on the first image.

4. The non-transitory computer-readable recording medium having recorded thereon the program according to claim 1, wherein the third image is provided based on a positional relationship between the two or more subjects in the first image.

5. The non-transitory computer-readable recording medium having recorded thereon the program according to claim 1,
wherein the functions further comprise providing a predetermined sound to a sound output device coupled to the computer apparatus, if the identified two or more subjects satisfy the predetermined condition.

6. The non-transitory computer-readable recording medium having recorded thereon the program according to claim 1, wherein the functions further comprise:
identifying two or more subjects in one or more images among a plurality of images from a plurality of imaging units; and
if the identified two or more subjects satisfy the predetermined condition, superimposing the predetermined effect either on a fourth image among the plurality of images or on one or more fifth images from the plurality of imaging device that is different from the plurality of images to generate the third image, and providing the third image.

7. The non-transitory computer-readable recording medium having recorded thereon the program according to claim 1, wherein the predetermined effect comprises an image that prompts to move positions of the subjects.

8. The non-transitory computer-readable recording medium having recorded thereon the program according to claim 1, wherein the subjects are wearable objects.

9. The non-transitory computer-readable recording medium having recorded thereon the program according to claim 1, wherein the functions further comprises:
receiving a plurality of images from the imaging device within a predetermined period in a time-series order;
storing the plurality of images; and
wherein if where the identified two or more subjects satisfy the predetermined condition in one or more images among the plurality of stored images, superimposing the predetermined effect on the one or more stored images or on one or more images from the imaging device that is different from the stored one or more images to generate one or more sixth images and providing the one or more sixth images.

10. The non-transitory computer-readable recording medium having recorded thereon the program according to claim 1, wherein the functions further comprises:
receiving an input related to the predetermined condition.

11. A computer apparatus comprising:
a controller configured to:
identify two or more targets in an input from an input device; and
superimpose a predetermined effect either on the first image or on a second image from the imaging device that is different from the first image to generate a third image and providing the third image, if the identified two or more subjects satisfy a predetermined condition.

12. A control method executed in a computer apparatus comprising:
identifying two or more subjects in a first image from a imaging device; and
superimposing a predetermined effect either on the first image or on a second image from the imaging device that is different from the first image, to generate a third image and providing the third image, if the identified two or more subjects satisfy a predetermined condition.
